(19) United States
(12) Patent Application Publication
(10) Pub. No.: US 2026/0029738 A1
(43) Pub. Date: Jan. 29, 2026

(54) IMAGE FORMING APPARATUS AND ADJUSTMENT METHOD CAPABLE OF SUPPRESSING OCCURRENCE OF DIFFERENCE IN AMOUNT OF VARIATION IN IMAGE QUALITY OF OUTPUT IMAGE AMONG PLURALITY OF IMAGE FORMING SPEEDS WITH SIMPLE CONTROL

(71) Applicant: KYOCERA Document Solutions Inc., Osaka (JP)

(72) Inventors: Masaru Watanabe, Osaka (JP); Makoto Matsumoto, Osaka (JP); Yasuaki Sakamoto, Osaka (JP); Ayato Morikami, Osaka (JP); Yukiko Kotani, Osaka (JP)

(21) Appl. No.: 19/270,978

(22) Filed: Jul. 16, 2025

(30) Foreign Application Priority Data
Jul. 26, 2024 (JP) 2024-120775

(51) Int. Cl. G03G 15/00; G03G 15/01; G03G 15/041; G03G 15/06

(52) U.S. Cl. CPC G03G 15/50; G03G 15/011; G03G 15/0121; G03G 15/0189; G03G 15/0415; G03G 15/065

(57) ABSTRACT

An image forming apparatus includes an image forming portion, an image formation processing portion, and an adjustment processing portion. The image forming portion includes an image carrier on which an electrostatic latent image is formed and a developing portion configured to use toner to develop the electrostatic latent image formed on the image carrier, and forms an image on the sheet conveyed by the sheet conveying portion. The image formation processing portion executes image formation processing for forming an image on each of the sheets sequentially conveyed using the image forming portion at any of a plurality of predetermined image forming speeds. The adjustment processing portion executes adjustment processing for adjusting an image quality of an output image output by the image forming portion each time an execution timing common to the plurality of image forming speeds arrives during the execution of the image formation processing.

### INCORPORATION BY REFERENCE

This application is based upon and claims the benefit of priority from the corresponding Japanese Patent Application No. 2024-120775 filed on Jul. 26, 2024, the entire contents of which are incorporated herein by reference.

### BACKGROUND

The present disclosure relates to an image forming apparatus and an adjustment method.

In an image forming apparatus such as a printer that forms an image based on image data on a sheet, adjustment processing for adjusting the image quality of an output image is executed. For example, there is known an image forming apparatus that executes the adjustment processing each time an image is formed on a predetermined reference number of sheets during execution of image formation processing for forming images on respective sheets that are sequentially conveyed.

Further, there is known an image forming apparatus that executes the image formation processing at one of a plurality of predetermined image forming speeds.

### SUMMARY

An image forming apparatus according to one aspect of the present disclosure includes a sheet conveying portion, an image forming portion, an image formation processing portion, and an adjustment processing portion. The sheet conveying portion conveys a sheet. The image forming portion includes an image carrier on which an electrostatic latent image is formed and a developing portion configured to use toner to develop the electrostatic latent image formed on the image carrier, and forms an image on the sheet conveyed by the sheet conveying portion. The image formation processing portion executes image formation processing for forming an image on each of the sheets sequentially conveyed by the sheet conveying portion using the image forming portion at any of a plurality of predetermined image forming speeds. The adjustment processing portion executes adjustment processing for adjusting an image quality of an output image output by the image forming portion each time a predetermined execution timing common to the plurality of image forming speeds arrives during the execution of the image formation processing.

An adjustment method according to another aspect of the present disclosure is performed by an image forming apparatus comprising a sheet conveying portion configured to convey a sheet, an image forming portion including an image carrier on which an electrostatic latent image is formed and a developing portion configured to use toner to develop the electrostatic latent image formed on the image carrier, and configured to form an image on the sheet conveyed by the sheet conveying portion, and includes an image forming step and an adjustment step. In the image forming step, image formation processing for forming an image on each of the sheets sequentially conveyed by the sheet conveying portion is executed using the image forming portion at any of a plurality of predetermined image forming speeds. In the adjustment step, adjustment processing for adjusting an image quality of an output image output by the image forming portion is executed each time a predetermined execution timing common to the plurality of image forming speeds arrives during the execution of the image formation processing.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a cross-sectional view showing a configuration of an image forming apparatus according to an embodiment of the present disclosure.

FIG. 2 is a block diagram showing a system configuration of the image forming apparatus according to the embodiment of the present disclosure.

FIG. 3 is a cross-sectional view showing a configuration of an image forming portion of the image forming apparatus according to the embodiment of the present disclosure.

FIG. 4 is a bottom view showing a configuration of an intermediate transfer belt of the image forming apparatus according to the embodiment of the present disclosure.

FIG. 5 is a flowchart showing an example of operation control processing executed in the image forming apparatus according to the embodiment of the present disclosure.

### DETAILED DESCRIPTION

Hereinafter, an embodiment of the present disclosure will be described with reference to the accompanying drawings. It is noted that the following embodiment is an example of embodying the present disclosure and does not limit the technical scope of the present disclosure.

### [Configuration of Image Forming Apparatus 100]

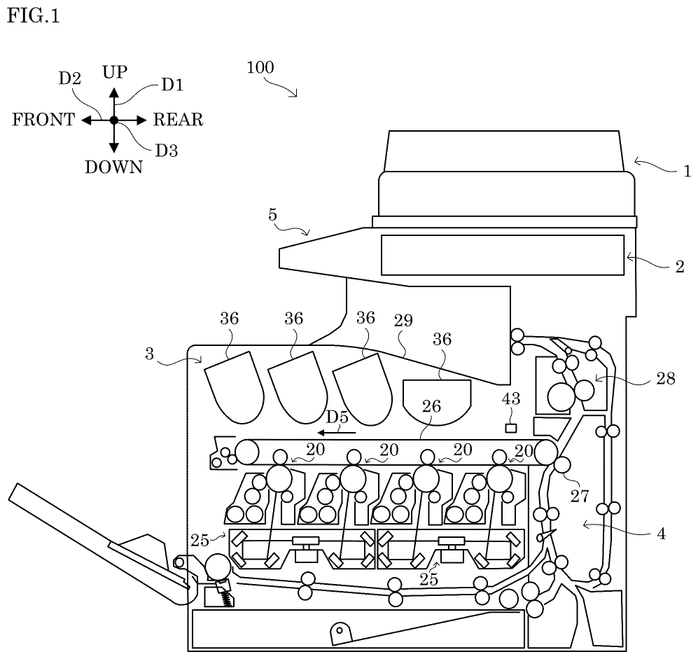

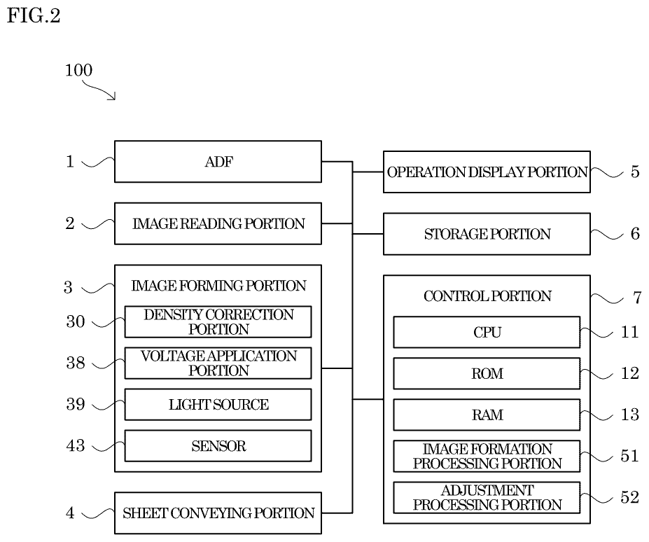

First, a configuration of an image forming apparatus 100 according to the embodiment of the present disclosure will be described with reference to FIG. 1 and FIG. 2.

It is noted that, for convenience of description, the vertical direction in an installation state (the state shown in FIG. 1) in which the image forming apparatus 100 can be used is defined as an up-down direction D1. In addition, a front-rear direction D2 is defined with the left side surface, on the paper surface, of the image forming apparatus 100 shown in FIG. 1 as the front side (front surface). In addition, a left-right direction D3 is defined with reference to the front side of the image forming apparatus 100 in the installation state.

The image forming apparatus 100 is a multifunction peripheral having a plurality of functions such as a facsimile function and a copy function in addition to a scan function for reading an image of a document sheet and a print function for forming an image based on image data. It is noted that the present disclosure may also be applied to image forming apparatuses, such as a printer, a facsimile machine, and a copier, capable of forming an image using an electrophotographic method.

As shown in FIG. 1 and FIG. 2, the image forming apparatus 100 includes an auto document feeder (ADF) 1, an image reading portion 2, an image forming portion 3, a sheet conveying portion 4, an operation display portion 5, a storage portion 6, and a control portion 7.

The ADF 1 conveys a document sheet to be read by the scan function. The ADF 1 includes a document sheet loading portion, a plurality of conveying rollers, a document sheet holder, and a sheet discharge portion.

The image reading portion 2 implements the scan function. The image reading portion 2 includes a document sheet table, a light source, a plurality of mirrors, an optical lens, and a charge coupled device (CCD).

The image forming portion 3 implements the print function. Specifically, the image forming portion 3 forms a color or monochrome image on a sheet supplied from the sheet conveying portion 4 in accordance with an electrophotographic method.

The sheet conveying portion 4 conveys a sheet. The image forming portion 3 forms an image on a sheet conveyed by the sheet conveying portion 4. The sheet conveying portion 4 includes a sheet feed cassette, a manual feed tray, and a plurality of conveying rollers.

The operation display portion 5 is a user interface of the image forming apparatus 100. The operation display portion 5 includes a display portion and an operation portion. The display portion displays various types of information in response to control instructions from the control portion 7. Specifically, the display portion is a display device such as a liquid crystal display. The operation portion inputs various types of information to the control portion 7 in response to user operations. Specifically, the operation portion is an operation device including an operation key and a touch panel.

The storage portion 6 is a nonvolatile storage device. For example, the storage portion 6 is a nonvolatile memory such as a flash memory.

The control portion 7 performs overall control of the image forming apparatus 100. As shown in FIG. 2, the control portion 7 includes a CPU 11, a ROM 12, and a RAM 13. The CPU 11 is a processor that executes various types of arithmetic processing. The ROM 12 is a nonvolatile storage device in which information such as control programs for causing the CPU 11 to execute various types of processing are stored in advance. The RAM 13 is a volatile or nonvolatile storage device used as a temporary storage memory (work area) for various types of processing executed by the CPU 11. The CPU 11 performs overall control of the image forming apparatus 100 by executing various control programs stored in the ROM 12 in advance.

It is noted that the control portion 7 may be a control portion provided separately from a main control portion that performs overall control of the image forming apparatus 100. In addition, the control portion 7 may be composed of an electronic circuit such as an integrated circuit (ASIC).

### [Configuration of Image Forming Portion 3]

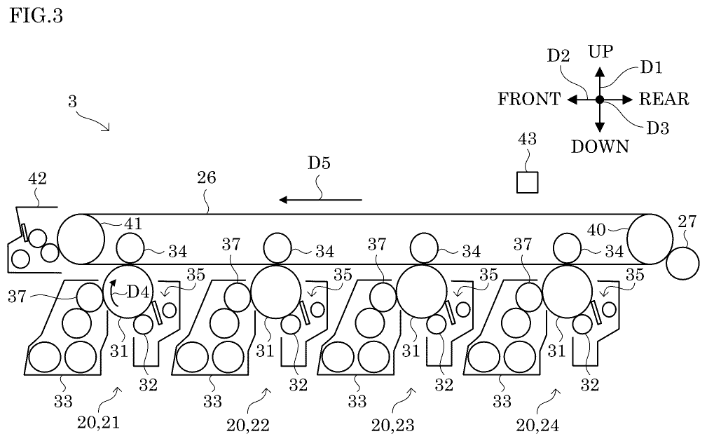

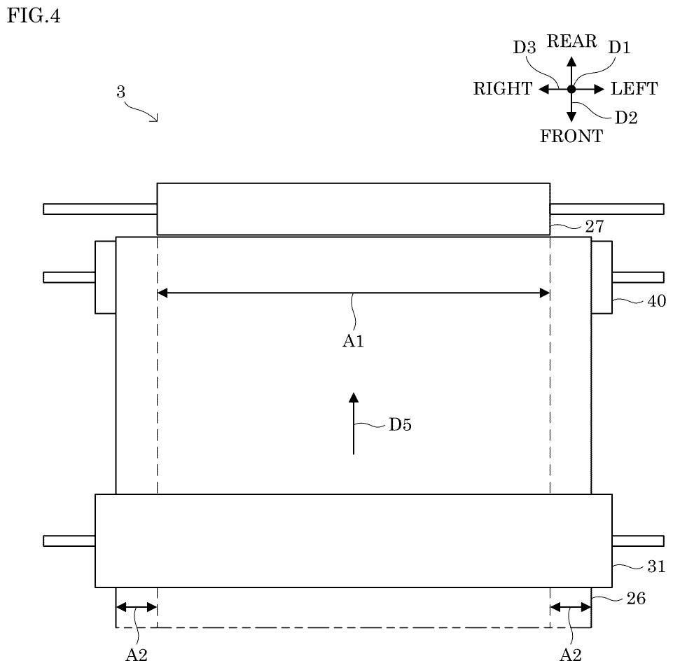

Next, a configuration of the image forming portion 3 will be described with reference to FIG. 1 to FIG. 4. Here, FIG. 3 is a cross-sectional view showing a configuration of a plurality of image forming units 20, an intermediate transfer belt 26, and a secondary transfer roller 27. In addition, FIG. 4 is a bottom view showing a configuration of a photoconductor drum 31 of an image forming unit 24, the intermediate transfer belt 26, a drive roller 40, and a secondary transfer roller 27.

As shown in FIG. 1, the image forming portion 3 includes four image forming units 20, two laser scanning units 25, an intermediate transfer belt 26, a secondary transfer roller 27, a fixing device 28, and a sheet discharge tray 29. In addition, as shown in FIG. 2, the image forming portion 3 includes a density correction portion 30, a voltage application portion 38, a light source 39, and a sensor 43.

Of the four image forming units 20, an image forming unit 21 (see FIG. 3) forms a yellow (Y) toner image. Of the four image forming units 20, an image forming unit 22 (see FIG. 3) forms a cyan (C) toner image. Of the four image forming units 20, an image forming unit 23 (see FIG. 3) forms a magenta (M) toner image. Of the four image forming units 20, an image forming unit 24 (see FIG. 3) forms a black (K) toner image. As shown in FIG. 1 and FIG. 3, the four image forming units 20 are arranged in the order of yellow, cyan, magenta, and black from the front side of the image forming apparatus 100 along the front-rear direction D2.

As shown in FIG. 3, each of the image forming units 20 includes a photoconductor drum 31, a charging roller 32, a developing device 33, a primary transfer roller 34, and a drum cleaning member 35. In addition, each of the image forming units 20 includes a toner container 36 shown in FIG. 1.

An electrostatic latent image is formed on the surface of the photoconductor drum 31. The photoconductor drum 31 rotates in a drum rotation direction D4 shown in FIG. 3 under rotational drive power supplied from a motor (not shown). Thus, the photoconductor drum 31 conveys the electrostatic latent image formed on its surface. The photoconductor drum 31 is an example of the image carrier of the present disclosure.

The charging roller 32 charges the surface of the photoconductor drum 31 under application of a preset charging voltage. For example, the charging roller 32 positively charges the surface of the photoconductor drum 31. The surface of the photoconductor drum 31 charged by the charging roller 32 is irradiated with light based on image data emitted from the laser scanning unit 25. Thus, an electrostatic latent image is formed on the surface of the photoconductor drum 31.

The developing device 33 uses toner to develop the electrostatic latent image formed on the surface of the photoconductor drum 31. The developing device 33 includes a pair of stirring members, a magnet roller, and a developing roller 37 (see FIG. 3). The pair of stirring members stir a developer containing toner and carrier stored inside the developing device 33. For example, the toner contained in the developer is positively charged by friction with the carrier contained in the developer. The magnet roller draws up the developer stirred by the pair of stirring members and supplies the toner contained in the developer to the developing roller 37. The developing roller 37 conveys the toner supplied from the magnet roller to a position facing the photoconductor drum 31. In addition, the developing roller 37 supplies the toner conveyed to the facing position to an electrostatic latent image formed on the photoconductor drum 31 in response to application of a preset developing bias voltage. Accordingly, the toner is selectively supplied to the exposed area of the photoconductor drum 31 irradiated with the light emitted from the laser scanning unit 25, and the electrostatic latent image formed on the surface of the photoconductor drum 31 is developed. The developing device 33 is an example of the developing portion of the present disclosure. In addition, the developing roller 37 is an example of the developing member of the present disclosure. It is noted that the developing device 33 is supplied with toner from the toner container 36.

The voltage application portion 38 is a power source capable of applying the developing bias voltage to the developing roller 37. The voltage application portion 38 is provided corresponding to each of the image forming units 20.

The primary transfer roller 34 is supplied with a preset primary transfer current and transfers the toner image formed on the surface of the photoconductor drum 31 to the outer peripheral surface of the intermediate transfer belt 26. As shown in FIG. 3, the primary transfer roller 34 is provided so as to face the photoconductor drum 31 with the intermediate transfer belt 26 interposed therebetween.

The drum cleaning member 35 removes toner remaining on the surface of the photoconductor drum 31 after the toner image transfer by the primary transfer roller 34.

The density correction portion 30 uses predetermined table data to correct the density of image data used to form the output image output by the image forming portion 3. Specifically, the density correction portion 30 corrects the density of the image data so that the relationship between the density of the image data input to the image forming portion 3 and the density of the output image is a linear relationship. That is, the density correction portion 30 executes so-called gamma correction. In addition, the table data is data indicating a gamma table used in the gamma correction.

The density correction portion 30 and the table data are provided for each printing color. The density correction portion 30 corresponding to Y (yellow) corrects the density of Y (yellow) image data based on first table data. The first table data is the table data corresponding to Y (yellow). The density correction portion 30 corresponding to C (cyan) corrects the density of C (cyan) image data based on second table data. The second table data is the table data corresponding to C (cyan). The density correction portion 30 corresponding to M (magenta) corrects the density of M (magenta) image data based on third table data. The third table data is the table data corresponding to M (magenta). The density correction portion 30 corresponding to K (black) corrects the density of K (black) image data based on fourth table data. The fourth table data is the table data corresponding to K (black).

The light source 39 emits light to be applied to the photoconductor drum 31. The light source 39 emits light based on image data obtained after the density correction by the density correction portion 30. The light source 39 is provided for each printing color.

The two laser scanning units 25 emit light based on image data toward the surfaces of the photoconductor drums 31 of the image forming units 20. The two laser scanning units 25 are arranged side by side along the front-rear direction D2.

Of the two laser scanning units 25, the laser scanning unit 25 disposed on the front side emits light based on Y (yellow) image data toward the photoconductor drum 31 of the image forming unit 21. In addition, the laser scanning unit 25 disposed on the front side emits light based on C (cyan) image data toward the photoconductor drum 31 of the image forming unit 22. Specifically, the laser scanning unit 25 disposed on the front side includes a light source 39 corresponding to Y (yellow), a light source 39 corresponding to C (cyan), a first polygon mirror common to Y (yellow) and C (cyan), a first optical path corresponding to Y (yellow), and a second optical path corresponding to C (cyan). The light emitted from the light source 39 corresponding to Y (yellow) is run in a main scanning direction along the left-right direction D3 by the first polygon mirror, and is applied to the photoconductor drum 31 of the image forming unit 21 via a lens and a mirror disposed on the first optical path. The light emitted from the light source 39 corresponding to C (cyan) is run in the main scanning direction by the first polygon mirror, and is applied to the photoconductor drum 31 of the image forming unit 22 via a lens and a mirror disposed on the second optical path.

Of the two laser scanning units 25, the laser scanning unit 25 disposed on the rear side emits light based on M (magenta) image data toward the photoconductor drum 31 of the image forming unit 23. In addition, the laser scanning unit 25 disposed on the rear side emits light based on K (black) image data toward the photoconductor drum 31 of the image forming unit 24. Specifically, the laser scanning unit 25 disposed on the rear side includes a light source 39 corresponding to M (magenta), a light source 39 corresponding to K (black), a second polygon mirror common to M (magenta) and K (black), a third optical path corresponding to M (magenta), and a fourth optical path corresponding to K (black). The light emitted from the light source 39 corresponding to M (magenta) is run in the main scanning direction by the second polygon mirror, and is applied to the photoconductor drum 31 of the image forming unit 23 via a lens and a mirror disposed on the third optical path. The light emitted from the light source 39 corresponding to K (black) is run in the main scanning direction by the second polygon mirror, and is applied to the photoconductor drum 31 of the image forming unit 24 via a lens and a mirror disposed on the fourth optical path. The laser scanning unit 25 runs light emitted from the light source 39 to form an electrostatic latent image on the photoconductor drum 31. The laser scanning unit 25 is an example of the latent image forming portion of the present disclosure.

The intermediate transfer belt 26 is an endless belt member to which a toner image formed on the surface of the photoconductor drum 31 of each of the image forming units 20 is transferred. The intermediate transfer belt 26 is stretched with a predetermined tension by a drive roller 40 (see FIG. 3) and a stretching roller 41 (see FIG. 3). The intermediate transfer belt 26 rotates in a belt rotation direction D5 shown in FIG. 3 as the drive roller 40 rotates under rotational drive power supplied from a motor (not shown). Thus, the intermediate transfer belt 26 conveys the toner image transferred from each of the photoconductor drums 31 to a transfer position for the secondary transfer roller 27 to transfer the toner image onto a sheet. It is noted that the outer peripheral surface of the intermediate transfer belt 26 after the toner image is transferred by the secondary transfer roller 27 is cleaned by a belt cleaning portion 42 (see FIG. 3).

The secondary transfer roller 27 is supplied with a preset secondary transfer current and transfers the toner image transferred to the outer peripheral surface of the intermediate transfer belt 26 to a sheet supplied from the sheet conveying portion 4. As shown in FIG. 3, the secondary transfer roller 27 is provided so as to face the drive roller 40 with the intermediate transfer belt 26 interposed therebetween.

As shown in FIG. 4, the size of the secondary transfer roller 27 in the axial direction (left-right direction D3) is smaller than the width of the intermediate transfer belt 26 (the size in the left-right direction D3). This causes a non-contact area A2 (see FIG. 4) that does not come into contact with the secondary transfer roller 27 to be formed on the outer peripheral surface of the intermediate transfer belt 26. The non-contact area A2 is an area outside a contact area A1 (see FIG. 4) that comes into contact with the secondary transfer roller 27 on the outer peripheral surface of the intermediate transfer belt 26, which includes end portions in the width direction of the intermediate transfer belt 26.

The fixing device 28 fixes the toner image transferred to the sheet by the secondary transfer roller 27 to the sheet.

The sheet to which the toner image has been fixed by the fixing device 28 is discharged to the sheet discharge tray 29.

The sensor 43 detects the density and position of the toner image transferred to the non-contact area A2 (see FIG. 4) on the outer peripheral surface of the intermediate transfer belt 26. For example, the sensor 43 is provided corresponding to each of the pair of non-contact areas A2. For example, the sensor 43 is a reflective optical sensor, and includes a light emitting portion that emits light toward the non-contact area A2 of the intermediate transfer belt 26 and a light receiving portion that receives light emitted from the light emitting portion and reflected by the non-contact area A2 of the intermediate transfer belt 26. As shown in FIG. 3, the sensor 43 is disposed downstream in the belt rotation direction D5 of the position where the toner image is transferred by the secondary transfer roller 27 and upstream in the belt rotation direction D5 of the position on the outer peripheral surface of the intermediate transfer belt 26 cleaned by the belt cleaning portion 42. The sensor 43 inputs electric signals corresponding to the density and position of the toner image to be detected to the control portion 7.

### [Configuration of Control Portion 7]

Next, a configuration of the control portion 7 will be described with reference to FIG. 2.

As shown in FIG. 2, the control portion 7 includes an image formation processing portion 51 and an adjustment processing portion 52.

Specifically, the ROM 12 of the control portion 7 stores in advance operation control programs for causing the CPU 11 to function as the respective processing portions described above. By executing the operation control programs stored in the ROM 12, the CPU 11 functions as the respective processing portions described above.

It is noted that the operation control programs may be recorded on a computer-readable recording medium such as a CD, a DVD, or a flash memory, and may be read from the recording medium and stored in a storage device such as the storage portion 6. In addition, some or all of the processing portions included in the control portion 7 may be constituted by electronic circuits. In addition, the operation control programs may be programs for causing a plurality of processors to function as the processing portions included in the control portion 7.

The image formation processing portion 51 executes image formation processing for forming an image on each of the sheets sequentially conveyed by the sheet conveying portion 4 using the image forming portion 3 at any of a plurality of predetermined image forming speeds. The image forming speed is a predetermined number of sheets printed per unit time. For example, the image forming speed is the number of sheets printed per minute.

For example, the image formation processing portion 51 executes the image formation processing at any one of a first image forming speed, a second image forming speed, and a third image forming speed. The first image forming speed is the fastest image forming speed among the plurality of image forming speeds. The second image forming speed is the second fastest image forming speed among the plurality of image forming speeds. The third image forming speed is the slowest image forming speed among the plurality of image forming speeds.

For example, when an instruction to execute the image formation processing is input, the image formation processing portion 51 executes the image formation processing at the image forming speed corresponding to the type of the sheet on which the output image is to be formed.

For example, when the type of the sheet on which the output image is to be formed is “thin paper”, the image formation processing portion 51 executes the image formation processing at the first image forming speed. When the type of the sheet on which the output image is to be formed is “plain paper”, the image formation processing portion 51 executes the image formation processing at the second image forming speed. When the type of the sheet on which the output image is to be formed is “thick paper”, the image formation processing portion 51 executes the image formation processing at the third image forming speed.

It is noted that the image formation processing portion 51 may determine the image forming speed to be applied when the image formation processing is executed, based on the basis weight of the sheet on which the output image is to be formed. Specifically, the image formation processing portion 51 may determine the image forming speed so that the larger the basis weight of the sheet on which the output image is to be formed, the slower the image forming speed to be applied when the image formation processing is executed.

The adjustment processing portion 52 executes adjustment processing for adjusting the image quality of the output image output by the image forming portion 3 during execution of the image formation processing.

For example, the adjustment processing includes a first adjustment process, a second adjustment process, a third adjustment process, and a fourth adjustment process.

The first adjustment process is a process of adjusting the developing bias voltage. When the developing bias voltage corresponding to one of the image forming units 20 changes, the density of the toner image formed by that image forming unit 20 changes. In other words, it can be said that the first adjustment process is a process of adjusting the image quality (density) of the output image.

For example, in the first adjustment process, a Y (yellow) first detection toner image is formed in each of the pair of non-contact areas A2 (see FIG. 4) on the intermediate transfer belt 26. That is, the first adjustment process includes a first toner image forming step of forming the first detection toner image on the photoconductor drum 31 of the image forming unit 21. The first detection toner image includes a plurality of first partial toner images arranged along the belt rotation direction D5 of the intermediate transfer belt 26. The plurality of first partial toner images are formed based on common image data. In addition, the plurality of first partial toner images are formed by applying developing bias voltages different from each other to the developing roller 37 of the image forming unit 21. In the first adjustment process, the sensor 43 is used to detect the densities of the first partial toner images included in the first detection toner image formed on the intermediate transfer belt 26. In addition, in the first adjustment process, a linear expression indicating the relationship between the voltage value of the developing bias voltage and the density of the toner image corresponding to the image forming unit 21 is obtained based on the results of detecting the densities of the first partial toner images. In the first adjustment process, the developing bias voltage corresponding to the image forming unit 21 is adjusted based on a voltage value corresponding to a predetermined density calculated using the obtained linear expression. The developing bias voltages corresponding to the other image forming units 20 are also adjusted in the same manner as the developing bias voltage corresponding to the image forming unit 21. In the first adjustment process, the four first detection toner images corresponding to the respective printing colors are sequentially formed, and the developing bias voltages corresponding to the respective printing colors are adjusted.

The second adjustment process is a process of adjusting the amount of light emitted from the light source 39. When the amount of light emitted from the light source 39 corresponding to one of the printing colors changes, the density of the toner image based on the electrostatic latent image formed by that light source 39 changes. In other words, it can be said that the second adjustment process is a process of adjusting the image quality (density) of the output image.

For example, in the second adjustment process, a Y (yellow) second detection toner image is formed in each of the pair of non-contact areas A2 (see FIG. 4) on the intermediate transfer belt 26. That is, the second adjustment process includes a second toner image forming step of forming the second detection toner image on the photoconductor drum 31 of the image forming unit 21. The second detection toner image includes a plurality of second partial toner images arranged along the belt rotation direction D5 of the intermediate transfer belt 26. The plurality of second partial toner images are formed based on common image data. In addition, the plurality of second partial toner images are formed by different amounts of light being emitted from the light source 39 corresponding to Y (yellow). In the second adjustment process, the sensor 43 is used to detect the densities of the second partial toner images included in the second detection toner image formed on the intermediate transfer belt 26. In addition, in the second adjustment process, a linear expression indicating the relationship between the amount of light emitted from the light source 39 corresponding to Y (yellow) and the density of the toner image is obtained based on the detection results of the densities of the second partial toner images. Then, in the second adjustment process, the amount of light emitted from the light source 39 corresponding to Y (yellow) is adjusted based on the amount of light corresponding to a predetermined density calculated using the obtained linear expression. The amounts of light emitted from the light sources 39 corresponding to the other printing colors are also adjusted in the same manner as the amount of light emitted from the light source 39 corresponding to Y (yellow). In the second adjustment process, the four second detection toner images corresponding to the respective printing colors are sequentially formed, and the amounts of light corresponding to the respective printing colors are adjusted.

The third adjustment process is a process of adjusting the table data. When the table data corresponding to one of the printing colors changes, the density of the toner image formed using the table data changes. In other words, it can be said that the third adjustment process is a process of adjusting the image quality (density) of the output image.

For example, in the third adjustment process, a Y (yellow) third detection toner image is formed in each of the pair of non-contact areas A2 (see FIG. 4) on the intermediate transfer belt 26. That is, the third adjustment process includes a third toner image forming step of forming the third detection toner image on the photoconductor drum 31 of the image forming unit 21. The third detection toner image includes a plurality of third partial toner images arranged along the belt rotation direction D5 of the intermediate transfer belt 26. The plurality of third partial toner images are formed based on a plurality of image data items with different Y (yellow) densities. Therefore, the plurality of third partial toner images formed on the intermediate transfer belt 26 have different densities. In the third adjustment process, the sensor 43 is used to detect the densities of the third partial toner images included in the third detection toner image formed on the intermediate transfer belt 26. In addition, in the third adjustment process, an expression indicating the relationship between the density of Y (yellow) image data input to the image forming portion 3 and the density of the toner image formed on the intermediate transfer belt 26 is obtained based on the result of detecting the densities of the third partial toner images. Then, in the third adjustment process, the table data corresponding to Y (yellow) is adjusted based on the obtained expression so that the density of Y (yellow) image data input to the image forming portion 3 and the density of the toner image formed on the intermediate transfer belt 26 have a linear relationship. The table data corresponding to each of the other printing colors is also adjusted in the same manner as the table data corresponding to Y (yellow). In the third adjustment process, four third detection toner images corresponding to the respective printing colors are sequentially formed, and the table data corresponding to each printing color is adjusted.

The fourth adjustment process is a process of adjusting the position on each of the photoconductor drums 31 at which the electrostatic latent image is formed by the laser scanning unit 25. When the position on one of the photoconductor drums 31 at which the electrostatic latent image is formed by the laser scanning unit 25 changes, the position on the sheet at which the toner image of the printing color corresponding to that photoconductor drum 31 is formed changes, causing a color registration error. In other words, it can be said that the fourth adjustment process is a process of adjusting the image quality (color shift) of the output image.

For example, in the fourth adjustment process, a Y (yellow) fourth detection toner image is formed in each of the pair of non-contact areas A2 (see FIG. 4) on the intermediate transfer belt 26. That is, the fourth adjustment process includes a fourth toner image forming step of forming the fourth detection toner image on the photoconductor drum 31 of the image forming unit 21. For example, the fourth detection toner image is a rectangular toner image formed based on predetermined image data. In the fourth adjustment process, the sensor 43 is used to detect the position (the position in the left-right direction D3 and the position in the belt rotation direction D5) of the fourth detection toner image formed on the intermediate transfer belt 26. Then, in the fourth adjustment process, the position on the photoconductor drum 31 of the image forming unit 21 at which the electrostatic latent image is formed is adjusted based on the result of the detection of the position of the fourth detection toner image. For example, in the fourth adjustment process, when the detection position of the fourth detection toner image in the left-right direction D3 deviates from a predetermined position, the position of the lens disposed on the first optical path is adjusted so that the deviation is eliminated. In addition, in the fourth adjustment process, when the detection position of the fourth detection toner image in the belt rotation direction D5 deviates from a predetermined position, the posture of the mirror disposed on the first optical path is adjusted so that the deviation is eliminated. The position on the photoconductor drum 31 of each of the other image forming units 20 at which the electrostatic latent image is formed is also adjusted in the same manner as the position on the photoconductor drum 31 of the image forming unit 21 at which the electrostatic latent image is formed. In the fourth adjustment process, the four fourth detection toner images corresponding to the respective printing colors are sequentially formed, and the position where the electrostatic latent image corresponding to each printing color is adjusted.

For example, the adjustment processing portion 52 executes one of the four adjustment processes selected according to a predetermined order each time an execution timing to be described later arrives.

By the way, in the image forming apparatus 100, the amount of charge of the toner changes from time to time during the execution of the image formation processing, whereby the density of the output image changes.

In the case where the image forming apparatus 100 executes the adjustment processing every time an image is formed on a predetermined reference number of sheets, the slower the image forming speed, the longer the execution interval of the adjustment processing. Therefore, there is a difference in the amount of variation in the image quality of the output image among the plurality of image forming speeds. In other words, the slower the image forming speed, the greater the amount of variation in the image quality of the output image. On the other hand, it is conceivable to set the reference number of sheets for each image forming speed. However, this configuration complicates the control of the image forming apparatus 100.

On the other hand, the image forming apparatus 100 according to the embodiment of the present disclosure can suppress the occurrence of a difference in the amount of variation in the image quality of the output image among a plurality of image forming speeds with simple control as described below.

Specifically, the adjustment processing portion 52 executes the adjustment processing each time a predetermined execution timing common to the plurality of image forming speeds arrives during the execution of the image formation processing.

Here, the execution timing is a timing that arrives at a cycle longer than the execution time of the adjustment processing when the adjustment processing is executed at the third image forming speed (an example of the specific image forming speed of the present disclosure), which is the slowest of the plurality of image forming speeds. Further, the execution timing is a timing that arrives at a cycle longer than the execution time of the adjustment processing when the adjustment process having the longest execution time among the plurality of adjustment processes is executed at the third image forming speed. By determining the execution timing in this way, when the adjustment processing is executed at the third image forming speed, it is possible to prevent the execution timing of the next adjustment processing from arriving before the adjustment processing is completed. For example, the execution timing is a timing at which the drive time of the developing device 33 reaches an integer multiple of a predetermined reference time. The reference time is a time longer than an execution time of the adjustment processing when the adjustment process having the longest execution time among the plurality of adjustment processes is executed at the third image forming speed. It is noted that the execution timing does not have to be a periodic timing.

It is noted that the adjustment processing may not include one or more of the first adjustment process, the second adjustment process, the third adjustment process, and the fourth adjustment process.

### [Operation Control Processing]

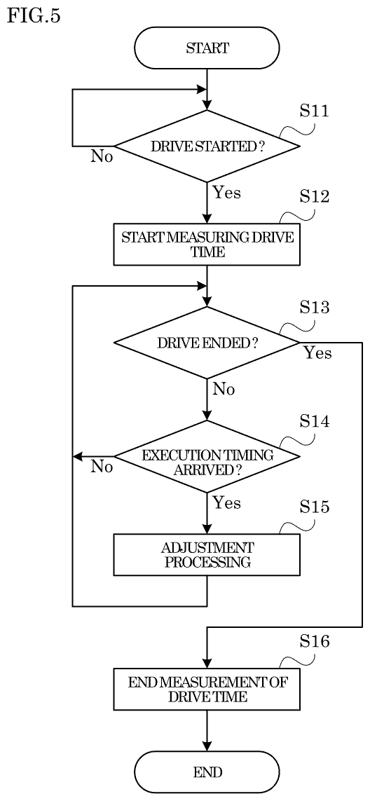

The adjustment processing of the present disclosure will be described below with reference to FIG. 5, along with an example of the procedure of the operation control processing executed by the control portion 7 in the image forming apparatus 100. Here, steps S11, S12, . . . represent the numbers of the processing procedure (steps) executed by the control portion 7. It is noted that the operation control processing is executed together with the image formation processing when an instruction to execute the image formation processing is input. Executing the image formation processing in response to an input of an instruction to execute the image formation processing is an example of the image forming step of the present disclosure, and is executed by the image formation processing portion 51 of the control portion 7.

### <Step S11>

First, in step S11, the control portion 7 determines whether or not the drive of the developing device 33 is started in accordance with the start of the image formation processing.

Here, when the control portion 7 determines that the drive of the developing device 33 has been started (Yes in S11), the control portion 7 shifts the processing to step S12. In addition, when the drive of the developing device 33 has not been started (No in S11), the control portion 7 waits for the start of the drive of the developing device 33 in step S11.

### <Step S12>

In step S12, the control portion 7 starts measuring the drive time of the developing device 33.

### <Step S13>

In step S13, the control portion 7 determines whether or not the drive of the developing device 33 has ended with the completion of the image formation processing.

When the control portion 7 determines that the drive of the developing device 33 has ended (Yes in S13), the control portion 7 shifts the processing to step S16. In addition, when the drive of the developing device 33 has not ended (No in S13), the control portion 7 shifts the processing to step S14.

### <Step S14>

In step S14, the control portion 7 determines whether or not the execution timing has arrived.

Specifically, the control portion 7 determines that the execution timing has arrived when the drive time of the developing device 33 measured by the process of step S12 reaches an integer multiple of the reference time.

Here, when the control portion 7 determines that the execution timing has arrived (Yes in S14), the control portion 7 shifts the processing to step S15. In addition, when the execution timing has not arrived (No in S14), the control portion 7 shifts the processing to step S13.

### <Step S15>

In step S15, the control portion 7 executes one of the four adjustment processes selected in accordance with a predetermined order. The process of step S15 is an example of the adjustment step of the present disclosure, and is executed by the adjustment processing portion 52 of the control portion 7.

### <Step S16>

In step S16, the control portion 7 ends the measurement of the drive time of the developing device 33.

As described above, in the image forming apparatus 100, the adjustment processing is executed each time the drive time of the developing device 33 during the execution of the image formation processing reaches an integer multiple of the reference time common to the plurality of the image forming speeds. Thus, compared with the configuration in which the adjustment processing is executed each time an image is formed on the reference number of sheets, it is possible to suppress occurrence of a difference in the amount of variation in the image quality of the output image among the plurality of image forming speeds. In addition, it is possible to prevent the control of the image forming apparatus 100 from being complicated as compared with the configuration in which the reference number of sheets is set for each image forming speed.

It is noted that the size of the secondary transfer roller 27 in the axial direction (left-right direction D3) may be the same as the width of the intermediate transfer belt 26 (size in the left-right direction D3). In this case, the sensor 43 may be disposed upstream in the belt rotation direction D5 of the position where the toner image is transferred by the secondary transfer roller 27 and downstream in the belt rotation direction D5 of the position where the toner image is transferred by the primary transfer roller 34 of the image forming unit 24. Between the sensor 43 and the position where the toner image is transferred by the secondary transfer roller 27, there may be a cleaning member that can move between a contact position where the cleaning member comes into contact with the intermediate transfer belt 26 and a retracted position where the cleaning member retreats from the contact position and that cleans the detection toner image formed by the adjustment processing. In the case where the execution timing arrives during the execution of the image formation processing and the toner image forming area corresponding to the output image overlaps with the detection toner image forming area of the intermediate transfer belt 26, the conveyance of the sheet by the sheet conveying portion 4 and the formation of the toner image corresponding to the output image by the image forming portion 3 may be temporarily stopped until the adjustment processing is completed.

### APPENDIXES OF INVENTION

The following are appendixes to the overview of the invention extracted from the above embodiment. It is noted that the structures and processing functions to be described in the following appendixes can be selected and combined arbitrarily.

### Appendix 1

An image forming apparatus comprising: a sheet conveying portion configured to convey a sheet; an image forming portion including an image carrier on which an electrostatic latent image is formed and a developing portion configured to use toner to develop the electrostatic latent image formed on the image carrier, and configured to form an image on the sheet conveyed by the sheet conveying portion; an image formation processing portion configured to execute image formation processing for forming an image on each of the sheet sequentially conveyed by the sheet conveying portion using the image forming portion at any of a plurality of predetermined image forming speeds; and an adjustment processing portion configured to execute adjustment processing for adjusting an image quality of an output image output by the image forming portion each time a predetermined execution timing common to the plurality of image forming speeds arrives during the execution of the image formation processing.

### Appendix 2

The image forming apparatus according to Appendix 1, wherein the adjustment processing includes a toner image forming step of forming a predetermined detection toner image on the image carrier, and the execution timing is a timing that arrives at a cycle longer than an execution time of the adjustment processing when the adjustment processing is executed at a slowest specific image forming speed among a plurality of image forming speeds.

### Appendix 3

The image forming apparatus according to Appendix 1 or 2, wherein the developing portion includes a developing member configured to supply the toner to the electrostatic latent image in response to application of a developing bias voltage, and the adjustment processing includes a first adjustment process of adjusting the developing bias voltage.

### Appendix 4

The image forming apparatus according to any one of Appendixes 1 to 3, wherein the image forming portion includes a light source configured to emit light to be applied to the image carrier, and the adjustment processing includes a second adjustment process of adjusting a light amount of the light emitted from the light source.

### Appendix 5

The image forming apparatus according to any one of Appendixes 1 to 4, wherein the image forming portion includes a density correction portion configured to use predetermined table data to correct a density of image data used for forming the output image, and the adjustment processing includes a third adjustment process of adjusting the table data.

### Appendix 6

The image forming apparatus according to any one of Appendixes 1 to 5, wherein the image forming portion includes a latent image forming portion configured to form the electrostatic latent image on the image carrier, and the adjustment processing includes a fourth adjustment process of adjusting a position on the image carrier where the electrostatic latent image is formed by the latent image forming portion.

### Appendix 7

An adjustment method performed by an image forming apparatus comprising a sheet conveying portion configured to convey a sheet and an image forming portion including an image carrier on which an electrostatic latent image is formed and a developing portion configured to use toner to develop the electrostatic latent image formed on the image carrier, and configured to form an image on the sheet conveyed by the sheet conveying portion, the adjustment method comprising: an image forming step of executing image formation processing for forming an image on each of the sheet sequentially conveyed by the sheet conveying portion using the image forming portion at any of a plurality of predetermined image forming speeds; and an adjustment step of executing adjustment processing for adjusting an image quality of an output image output by the image forming portion each time a predetermined execution timing common to the plurality of image forming speeds arrives during the execution of the image formation processing.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
a sheet conveying portion configured to convey a sheet;
an image forming portion including an image carrier on which an electrostatic latent image is formed and a developing portion configured to use toner to develop the electrostatic latent image formed on the image carrier, and configured to form an image on the sheet conveyed by the sheet conveying portion;
an image formation processing portion configured to execute image formation processing for forming an image on each of the sheet sequentially conveyed by the sheet conveying portion using the image forming portion at any of a plurality of predetermined image forming speeds; and
an adjustment processing portion configured to execute adjustment processing for adjusting an image quality of an output image output by the image forming portion each time a predetermined execution timing common to the plurality of image forming speeds arrives during the execution of the image formation processing.

2. The image forming apparatus according to claim 1, wherein
the adjustment processing includes a toner image forming step of forming a predetermined detection toner image on the image carrier, and
the execution timing is a timing that arrives at a cycle longer than an execution time of the adjustment processing when the adjustment processing is executed at a slowest specific image forming speed among a plurality of image forming speeds.

3. The image forming apparatus according to claim 1, wherein
the developing portion includes a developing member configured to supply the toner to the electrostatic latent image in response to application of a developing bias voltage, and
the adjustment processing includes a first adjustment process of adjusting the developing bias voltage.

4. The image forming apparatus according to claim 1, wherein
the image forming portion includes a light source configured to emit light to be applied to the image carrier, and
the adjustment processing includes a second adjustment process of adjusting a light amount of the light emitted from the light source.

5. The image forming apparatus according to claim 1, wherein
the image forming portion includes a density correction portion configured to use predetermined table data to correct a density of image data used for forming the output image, and
the adjustment processing includes a third adjustment process of adjusting the table data.

6. The image forming apparatus according to claim 1, wherein
the image forming portion includes a latent image forming portion configured to form the electrostatic latent image on the image carrier, and
the adjustment processing includes a fourth adjustment process of adjusting a position on the image carrier where the electrostatic latent image is formed by the latent image forming portion.

7. An adjustment method performed by an image forming apparatus comprising a sheet conveying portion configured to convey a sheet and an image forming portion including an image carrier on which an electrostatic latent image is formed and a developing portion configured to use toner to develop the electrostatic latent image formed on the image carrier, and configured to form an image on the sheet conveyed by the sheet conveying portion, the adjustment method comprising:
an image forming step of executing image formation processing for forming an image on each of the sheet sequentially conveyed by the sheet conveying portion using the image forming portion at any of a plurality of predetermined image forming speeds; and
an adjustment step of executing adjustment processing for adjusting an image quality of an output image output by the image forming portion each time a predetermined execution timing common to the plurality of image forming speeds arrives during the execution of the image formation processing.
